(19) United States
(12) Patent Application Publication
(10) Pub. No.: US 2025/0198237 A1
(43) Pub. Date: Jun. 19, 2025

(54) LADDER, LADDER TOP AND LADDER TOP ACCESSORY

(71) Applicant: Werner Co., Greenville, PA (US)

(72) Inventors: Robert Grant McRorie, III, Huntersville, NC (US); Juan Carlos Perez, Huntersville, NC (US)

(21) Appl. No.: 18/979,296

(22) Filed: Dec. 12, 2024

Related U.S. Application Data
(60) Provisional application No. 63/610,813, filed on Dec. 15, 2023.

(51) Int. Cl. E06C 7/14

(52) U.S. Cl. CPC E06C 7/14

(57) ABSTRACT

Provided herein is a ladder or other similar structure that includes a top thereof with features permitting easy use and access to tools or other items. In some aspects, a ladder is provided having a ladder top including mating geometry that enables coupling of an extension piece, tray, and/or section to the ladder top. In some aspects, a ladder is provided having a ladder top with a movable portion, such as a sliding upper portion, that permits a user to adjust or expand a work surface of the ladder top and/or permits access to items stored in a lower portion of the ladder top.

### CROSS-REFERENCE TO RELATED APPLICATION

This application claims the benefit of U.S. Provisional Application No. 63/610,813 filed Dec. 15, 2023, which is incorporated herein by reference in its entirety.

### TECHNICAL FIELD

This disclosure generally relates to ladders and, in particular, to ladders having ladder tops and accessories thereof.

### BACKGROUND

Carpenters, painters, electricians, technicians and the like often use ladders or other supporting structures while working. These individuals benefit from having easy access to their tools and small items during their tasks. Holding and using such tools and items while on a ladder or other structure can be inconvenient and may decrease efficiency. Additionally, it is important for these individuals to have their items organized in a manner that allows for easy location and retrieval when needed.

### BRIEF DESCRIPTION OF THE DRAWINGS

FIG. 1 is a perspective view of a ladder top and a ladder top extension in accordance with some embodiments.

FIG. 2 is a perspective view of a ladder top and a ladder top extension coupled to the ladder top in use in accordance with some embodiments.

FIG. 3 is a top perspective view of a ladder top in accordance with some embodiments.

FIG. 4 is a side perspective view of the ladder top of FIG. 3 in use in accordance with some embodiments.

FIG. 5A is a front perspective view of a ladder top in accordance with some embodiments, FIG. 5A showing the ladder top in a closed configuration.

FIG. 5B is a rear perspective view of the ladder top of FIG. 5A in the closed configuration.

FIG. 6 is a front perspective view of the ladder top of FIG. 5A in an open configuration.

FIG. 7A is a perspective view of a base of the ladder top of FIG. 5A.

FIG. 7B is a side view of the ladder top base of FIG. 7A.

FIG. 8 is a bottom perspective view of a lid of the ladder top of FIG. 5A.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Provided herein is a ladder or other similar structure that includes a top thereof that permits easy access to and manipulation of tools and accessories. The improved access to tools and accessories can improve the experience of the user when using the ladder. In one illustrative example, the ladder may be a stepladder ladder with a ladder top that includes geometry to facilitate easy use and access to tools or other items positioned at the ladder top. The ladder top may provide an adjustable size work surface for the user when working on the ladder. The ladder top may also provide an improved work surface capable of stowing a variety of tools or accessories thereof. By one approach, the ladder tops and accessories described herein include a number of aspects that permit the ladder top to be easily reconfigured to address a variety of user needs.

In some embodiments, the ladder top includes mating geometry that enables coupling of an extension piece, tray, and/or section. In this manner, the size of the usable work surface of the ladder top may be increased. Increasing the size of the work surface of the ladder top may, for example, provide a user with a surface sufficiently large enough to rest a tool bag or a computer upon. In addition, the extended ladder top may have a ledge, rim, rib, and/or other geometry to inhibit, or reduce the likelihood of, objects sliding off of the extended ladder top, for example, when a user accidently pushes the objects resting on the extended ladder top.

In yet another embodiment, the ladder top includes a main portion, such as a lower body, and a movable portion, such as a sliding upper body, movable relative to the lower body. The sliding upper body may be moved relative to the lower body to permit a user to adjust or expand the size of the work surface of the ladder top and permit access to items in the lower body of the ladder top. By one approach, the lower body is not movable relative to the ladder rails but may include geometry to facilitate easy access to and organization of items therein. In addition, in some embodiments, the geometry of the sliding upper body and the geometry of the fixed lower body cooperate to permit the user to easily reconfigure the ladder top in an easy and quick manner.

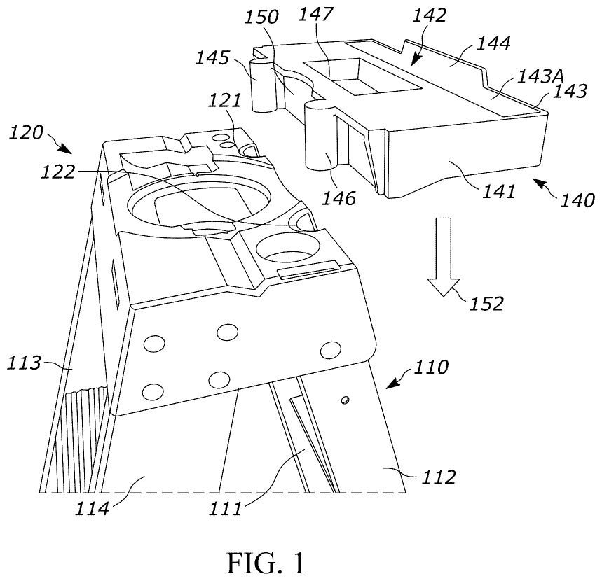

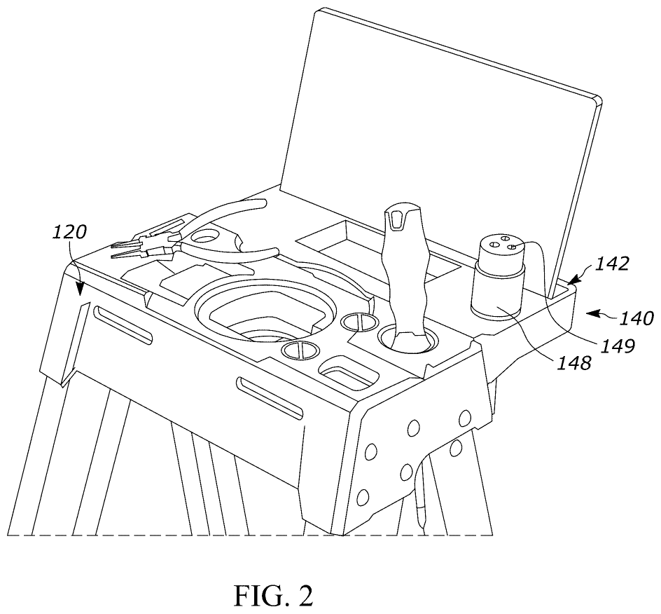

Referring now to the drawings, and in particular to FIGS. 1 and 2, a ladder top 120 and ladder top extension 140 are illustrated, in accordance with some embodiments. In FIG. 1, the ladder top extension 140 is detached from the ladder top 120. In FIG. 2, the ladder top extension 140 is attached/coupled to the ladder top 120.

The ladder top 120 may be attached/coupled to one or more rails 111, 112, 113, 114 of a step ladder 110 (though the ladder top 120 and others described herein may be incorporated into other ladders, such as, e.g., podium ladders, extension ladders, and others). In some embodiments, the step ladder 110 may include a first and second front rails 113, 114 and first and second rear rails 111, 112. The step ladder 110 may include one or more steps between the first and second front rails 113, 114 and/or the first and second rear rails 111, 112.

In some embodiments, the ladder top extension 140 is configured to be selectively attached/coupled to the ladder top 120. In this manner, the ladder top extension 140 is typically detachable. Coupling the ladder top extension 140 to the ladder top 120 may provide additional usable workspace to place/store tools, items, and/or devices while a user works from the ladder. The ladder top extension 140 may be detached from the ladder top 120 when the additional workspace is not needed, for example, during transport and storage.

The ladder top extension 140 may include an extension body such as extension tray 141 and an engagement mechanism configured to engage with the ladder top 120. For example, the ladder top extension 140 includes mating geometry that mates with mating geometry of the ladder top 120 to removably attach the ladder top extension 140 to the ladder top 120. By some approaches, the engagement mechanism includes one or more protrusions 145, 146 extending from the extension tray 141. The one or more protrusions 145, 146 are configured to engage (e.g., mate) with one or more retention or holder slots 121, 122 on the ladder top 120 or other support structures. In some aspects, the one or more protrusions 145, 146 may include a cylindrical shaped member. The one or more cylindrical shaped members may extend outward of and along an end surface 150 (e.g., a front end surface) of the extension tray 141. In some forms, the cylindrical shaped members are tapered from an upper end thereof to a lower end thereof.

In some configurations, the extension tray 141 of the ladder top extension 140 includes an elongate recess 142 on the top surface thereof. The elongate recess 142, in some configurations, is at a rear of the extension tray 141, such as the side of the extension body opposite the protrusions 145, 146. In some embodiments, the mouth or opening of the elongate recess 142 may have a generally rectangular shape. The bottom surface of the elongate recess 142 may have a generally rectangular shape. In some embodiments, the bottom surface of the elongate recess may be smaller than (e.g., narrower than) the opening of the elongate recess 142 such that the elongate recess tapers inward from the opening to the bottom surface thereof. In some embodiments, the elongate recess 142 may have a generally hexahedron shape. The elongate recess 142 may receive a tool or device that has a corresponding shape. In some embodiments, the elongate recess 142 may be configured to receive and support a mobile electronic device for example, a laptop, tablet computer, smart phone, etc.

With respect to the ladder top extension 140, the side from which the protrusions 145, 146 extend is referred to as a front side and the side opposite the front side is referred to as a rear side. The elongate recess 142 may be adjacent to the rear side of the extension tray 141. In some embodiments, the length of the elongate recess 142 may be slightly smaller than the length of the extension tray 141. For example, the elongate recess 142 may extend along a substantial portion of the length of the rear side of the extension tray 141.

In some embodiments, a rear wall 143 of the elongate recess 142 includes a rear surface 143A that is angled or tapered. In some embodiments, the rear surface 143A of the recess is angled or tapered inward relative to the axis perpendicular to the bottom surface of the elongate recess 142 about 1-20 degrees. In other words, the angle between the rear surface 143A of the recess 142 and the bottom surface of the elongate recess 142 may be 91 degrees to 120 degrees. In some embodiments, the angled or tapered angle of the rear surface 143A of the recess 142 may be 1-10 degrees, and in some forms, 5-10 degrees. In some embodiments, the angle or taper of the rear surface 143A of the elongate recess 142 may be 7 degrees. The sloped rear surface 143A of the elongate recess 142 may support a display device or mobile electronic device placed in the elongate recess 142 at a proper viewing angle for a user standing on the ladder, for example, as shown in FIG. 2.

The rear wall 143 of the ladder top extension 140 may further include a flange 144 extending upward from the elongate recess 142. The flange 144 may inhibit an object placed on the ladder top 120 and/or ladder top extension 140 from sliding off the ladder top 120 and/or ladder top extension 140. For example, the flange 144 may aid to hold a laptop in position when placed on the ladder top 120 and/or ladder top extension 140. The flange 144 may be tilted rearward from a vertical axis. The flange 144 may have a tilting angle that is the same as the tiling angle of the rear surface 143A of the elongate recess 142. The flange 144 may allow the elongate recess 142 to accommodate a large device, for example, by increasing the length of support provided by the rear wall 143 to the device. In some embodiments, the length of the flange 144 may be shorter than the length of the elongate recess 142. The shortened length of the flange 144 may still support the large device but may reduce the material to form the flange 144.

In some embodiments, the ladder top extension 140 may further include an additional recess 147 to accommodate tools, items, and small devices. Recesses having other shapes or geometry and/or organizational tools may also be incorporated into one or both of the ladder top 120 or the ladder top extension 140.

Referring to FIG. 2, which is similar to FIG. 1 but includes some additional geometry, the ladder top extension 140 may further include, e.g., a plug holder 148. The plug holder 148 may include one or more holes/slots 149 into which an end of an electrical plug (e.g., a power cord plug) can be inserted, clipped, and/or secured. In some embodiments, the plug holder 148 may have a generally cylindrical shape. The holes/slots 149 to accommodate/receive the end of the power cord plug may have a configuration corresponding to an electrical plug. For example, the holes/slots 149 on the plug holder 148 may correspond to type A plug or a type B plug which are commonly used in the United States. In some embodiments, when the mobile electronic device is placed on the elongate recess 142, the end of an extension power cord of the mobile electronic device may be inserted into the holes/slots 149 on the plug holder such that the extension power cord of the mobile electronic device may be safely placed/stored.

Returning to FIG. 1, the ladder top 120 may include one or more retention/holder slots 121, 122. The protrusions 145, 146 of the ladder top extension 140 may be placed in the one or more holder slots 121, 122 when the ladder top extension 140 is attached to the ladder top 120. For example, the protrusions 145, 146 may be aligned with the holder slots 121, 122 and the protrusions 145, 146 inserted into the slots 121, 122 (e.g., moved in direction 152) to attach the ladder top extension 140 to the ladder top 120.

In some embodiments, the one or more retention or holder slots 121, 122 may have a generally cylindrical shape corresponding to the shape of the cylindrical member of the protrusions 145, 146 of the ladder top extension 140. To attach the ladder top extension 140 to the ladder top 120, the axes of the cylindrical members of the protrusions 145, 146 are aligned with the axes of the cylindrical holder slots 121, 122 and the protrusions 145, 146 moved axially to insert the protrusions 145, 146 into the holder slots 121, 122.

The one or more holder slots 121, 122 may open to a top and rear side of the ladder top 120. When the one or more protrusions 145, 146 are inserted into the one or more holder slots 121, 122 to engage with the one or more holder slots 121, 122, the one or more cylindrical members of the one or more protrusion 145, 146 may be inserted through the one or more top openings of the one or more holder slots 121, 122.

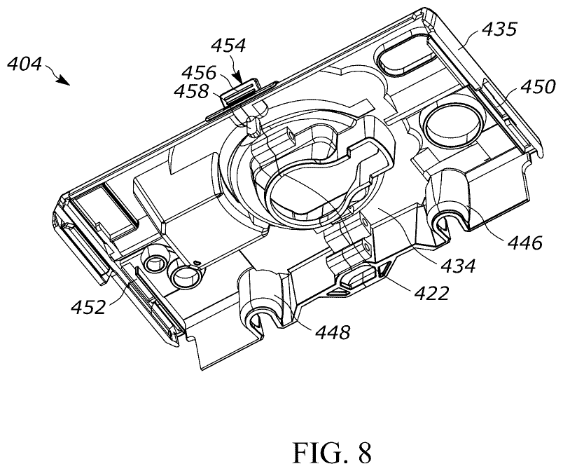

In some embodiments, the one or more holder slots 121, 122 have an at least partially closed bottom and/or be tapered to limit insertion of the protrusions 145, 146 into the holder slots 121, 122 (e.g., as shown in the embodiment of FIG. 8). In some embodiments, the one or more holder slots 121, 122 open to bottom side of the ladder top 120. In this case, the holder slots 121, 122 may have a ledge extending inwardly from the inner surface of the slots (e.g., from the holder slot forming surface). The ledge may be disposed at the lower portion of the slots 121, 122. The ledge may be configured to support the protrusions 145, 146 of ladder top extension 140. When the protrusions 145, 146 are inserted to and engage with the holder slots 121, 122, the cylindrical members of the protrusions 145, 146 may sit on the ledge so that the cylindrical members of the protrusions do not advance all the way through the holder slots 121, 122.

Some embodiments incorporate the some or all feature of the ladder system, the step ladder, ladder top, engagement mechanism, protrusions to engage with a ladder top, methods and/or processes described in International Patent Application No. PCT/US2023/027368 entitled CONTAINER AND ORANIZATIONAL SYSTEMS, filed on Jul. 11, 2023, which is incorporated herein by reference in its entirety.

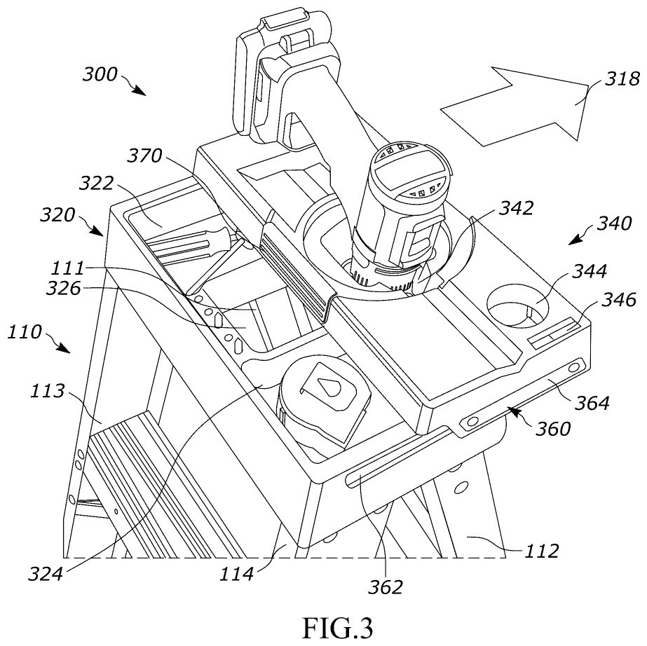

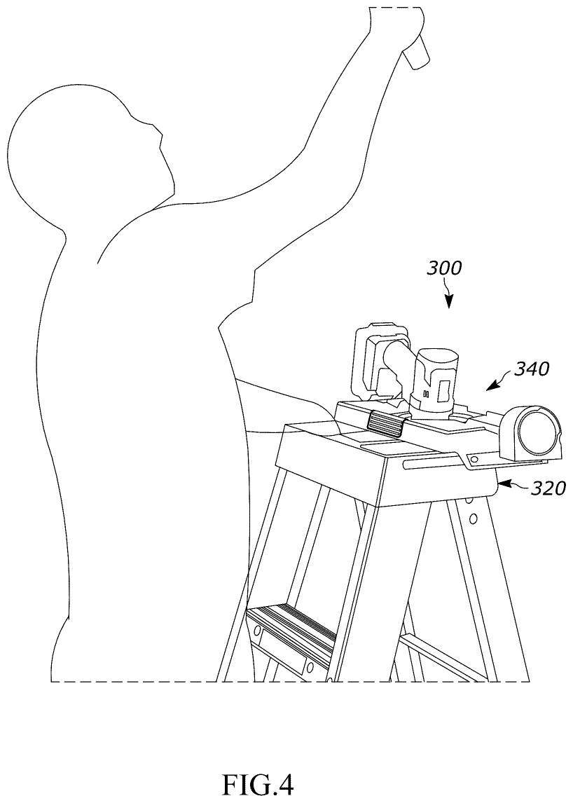

FIGS. 3 and 4 illustrate another embodiment of a ladder top 300. In some embodiments, the ladder top 300 may include a main body such as lower body 320 configured to be coupled to one or more rails 111, 112, 113, 114 of the step ladder 110 and an upper sliding/slidable portion, such as a sliding/slidable upper portion 340 movably coupled to the lower body 320 of the ladder top 300. The lower body may include one or more storage compartments 322, 324 to contain tools and small items (e.g., hardware such as screws, wire nuts, etc.). The sliding upper portion 340 may be movable between an open position as shown and a closed position by moving/sliding the upper portion 340 back and forth. When the sliding upper portion 340 is in the closed position, the sliding upper portion 340 is in alignment with the lower body 320 and covers the storage compartments 322, 324 of the lower body 320. The upper portion 340 may be moved in direction 318 to move the upper portion 340 to the open position from the closed position. The upper portion 340 may be moved in the direction opposite 318 to move the upper portion from the open position to the closed position.

In some embodiments, to allow the sliding upper portion 340 to move/slide back and forth, the ladder top 300 includes a sliding mechanism 360. In some embodiments, the sliding mechanism 360 may include a guide slot 362 on the lower body 320 of the ladder top 300 and a sliding assembly 364 coupled to the sliding upper portion 340. The sliding assembly 364 may include a protrusion that extends into the guide slot 362 such that the protrusion slides along the guide slot 362 when moving between the open position and closed position. The sliding mechanism 360 of the lower body 320 may include a guide slot 362 on both sides of the lower body 320. The sliding assembly 364 of the upper portion 340 may include a protrusion on both sides of the upper portion 340 to engage the guide slots 362. In some embodiments, the sliding assembly 364 on the sliding upper portion 340 may include metallic materials. In some embodiments, the outer rail of the sliding assembly 364 may be made of a metallic material such that the outer rail of the sliding assembly 364 may provide additional tool storage by allowing tools with a magnetic portion to be attached to the metallic outer rail of the sliding assembly 364. In some embodiments, the sliding assembly 364 may be a bearing assembly including, but not limited to, a rolling bearing such as a ball bearing and a roller bearing, or a sleeve bearing and bearing rails along which the bearing unit moves. In some embodiments, the bearing assembly may include a metallic bearing and metallic bearing rail. The metallic components may provide a more robust sliding assembly 364 than a plastic only sliding assembly. In some embodiments, the sliding mechanism 360 may include a self-lubricating plastic on the sliding surface to reduce the friction while the sliding upper portion 340 is moving/sliding.

In some embodiments, the ladder top 300 further includes a locking latch 370. The locking latch 370 is configured to securely lock the sliding upper portion 340 in the open position and/or the closed position.

In some embodiments, the locking latch 370 may be equipped with a spring that is under tension, ensuring that the latch 370 is normally locked when the upper portion 340 is at the open or closed position until it is intentionally released. A user may unlock the latch 370 by biasing the locking latch 370 to a lower position (e.g., rotating top end of the lacking latch 370 about the fixed bottom end of the lacking latch 370 by pulling the top end of the locking latch 370), allowing the spring tension for locking to be released. The locking latch 370 may prevent unintended/accidental movement of the sliding upper portion 340. The other types/mechanisms of locking latch that enable securing the sliding upper portion 340 in the open/closed position may be used.

By securely locking the sliding upper portion 340 in the closed position, tools and other items in the storage compartments 322, 324 of the lower body 320 may be securely contained and organized. Further, locking the sliding upper portion 340 in the open position may provide uninhibited access to the storage compartments 322, 324 of the lower body 320 while working from the ladder and may prevent unintended closing of the sliding upper portion 340. The sliding upper portion 340 also may be locked or secured in the closed position for adjustment and travel of the ladder between locations.

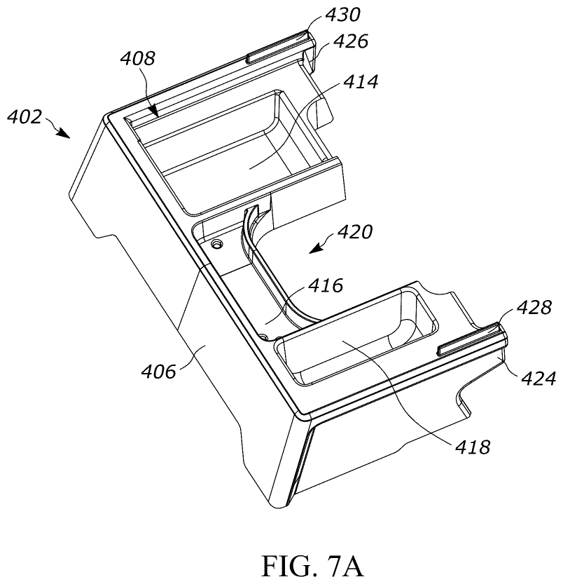

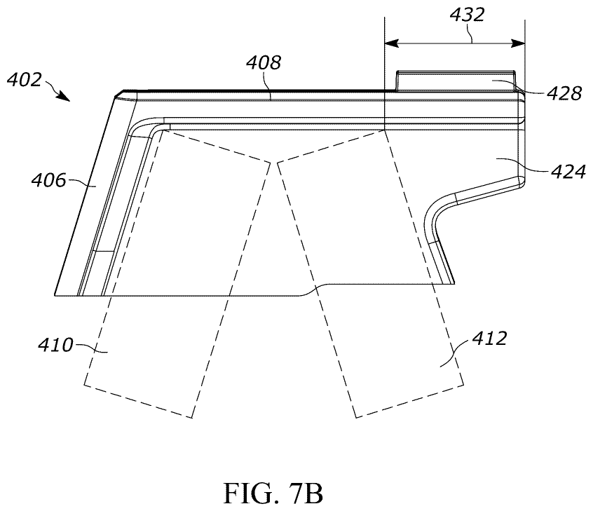

In some embodiments, the sliding upper portion 340 may have a tool slot 342 to place a tool/device such as a drill or a hammer. When a tool/device like a drill or a hammer is placed in the tool slot 342, at least portion of the tool may pass through the tool slot 342 and be placed beneath the tool slot 342 and/or sliding upper portion 340. To accommodate the portion of the tool beneath the sliding upper portion 340, the lower body 320 has a lower tool slot 326. In some embodiments, to accommodate the portion of the tool extending under the sliding upper portion 340 and to allow the sliding upper portion 340 to move from the closed position to the open position without removing the tool placed in the tool slot 342, the lower tool slot 326 may have an elongated shape. In some embodiments, the lower tool slot 326 may be elongated and open to the rear surface of the lower body 320 such that the lower tool slot 326 is open to top, bottom, and rear side (e.g., similar to that shown in the embodiment of FIG. 7A). In this manner, the lower body 320 may appear to have two discrete rear wall sections, though they are connected via the front portion of the lower body 320. In another configuration, the lower tool slot 326 may extend all the way to the front wall of the lower body 320.

In some embodiments, the sliding upper portion 340 may further include one or more additional tool slots 344, 346. In FIG. 4, a tape measure is held by the ladder top 300 by using the additional tool slot 346, for example, by clipping the tape measure to the upper portion 340 using the tool slot 346.

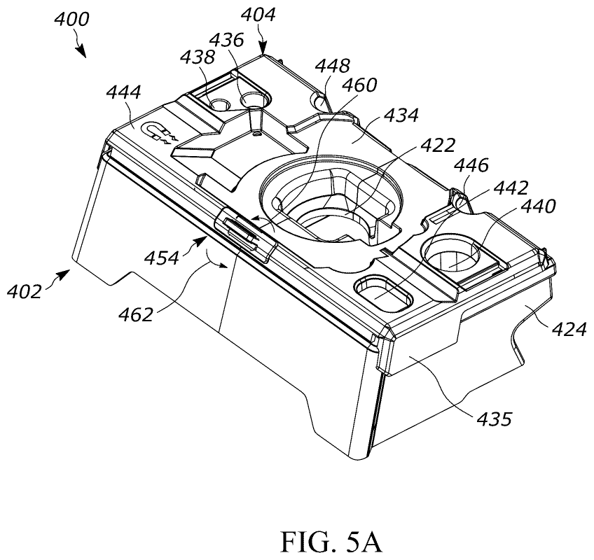

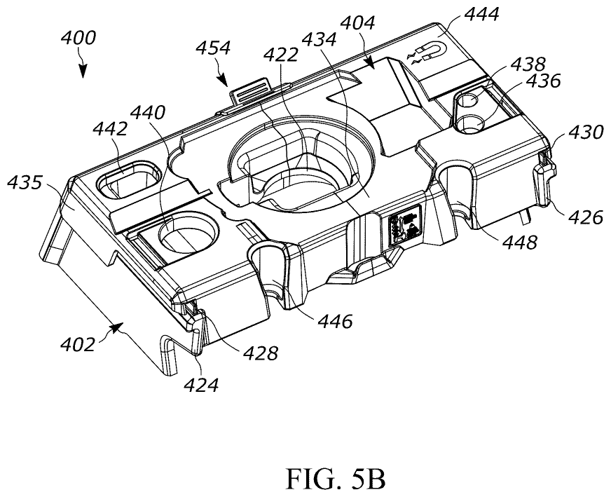

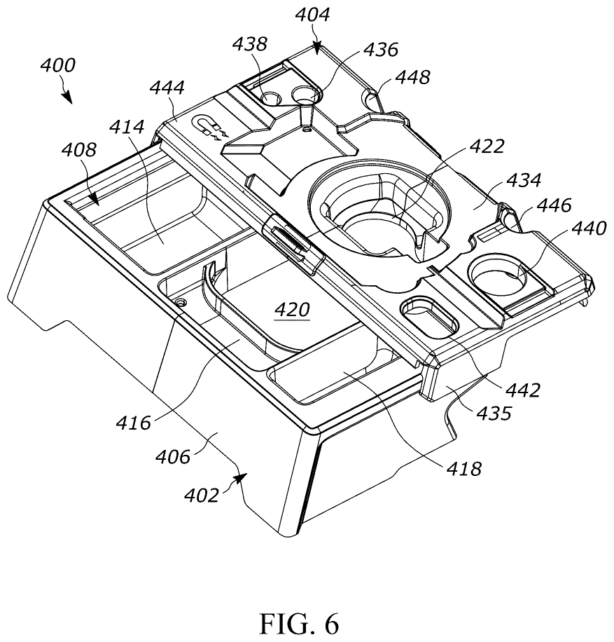

With respect to FIGS. 5A-8, a ladder top 400 is provided according to another embodiment. The ladder top 400 is similar to the ladder top 300 discussed above such that the differences are primarily highlighted and discussion of similar features are not repeated for conciseness and clarity. The ladder top 400 includes a main portion such as a lower body 402 and a sliding portion such as an upper body 404. The lower body 402 may be coupled to the upper end of rails of a ladder similar to the embodiments above. The upper body 404 is movably coupled to the lower body 402 to permit the upper body 404 to be moved relative to the lower body 402 between a closed position (shown in FIGS. 5A-5B) and an open position (shown in FIGS. 6).

Regarding FIGS. 7A-7B, the lower body 402 includes side walls 406 to attach to the rails 410, 412 of the ladder and a tray portion 408 between the side walls 406. The tray portion 408 includes storage compartments 414, 416, 418 of different sizes and shapes to store tools and/or accessories therein. The tray portion 408 further includes an open slot portion 420 into which a tool may extend through an opening 422 of the upper body 404. The open slot portion 420 permits the upper body 404 to be moved from the closed position to the open position even when the tool extends downward from the upper body 404 to the lower body 402.

The lower body 402 includes extension portions 424, 426 that extend from the tray portion 408 outward of the rear rails 412. In other words, the extension portions 424, 426 increase the distance 432 the lower body 402 extends outward or rearwardly of the rear rails 412. The extension portions 424, 426 provide support for the upper body 404 when the upper body 404 is moved to the open position. The extension portions 424, 426 increase the distance the upper body 404 is able to slide or travel from the closed position to the open position which may increase the area of the tray portion 408 and/or storage compartments 414, 416, 418 uncovered when the upper body 404 is in the open position, improving access thereto.

The lower body 402 typically includes flanges such as rails 428, 430 extending from the extension portions 424, 426. The rails 428, 430 guide movement of the upper body 404 along the lower body 402 as the lower body 402 is slid between the open position and closed position.

Regarding FIGS. 5A-6 and 8, the upper body 404 includes a tray portion 434 and sidewalls 435 depending from the tray portion 434. Similar to the previous embodiments, the tray portion 434 of the upper body 404 includes storage openings or slots 422, 436, 438, 440, 442 into which tools or accessories may be positioned for storage at the ladder top 400. The tray portion 434 may include one or more magnet therein such that the tray portion 434 includes a region 444 to which ferromagnetic materials (e.g., hardware or tools) may be secured to the tray portion 434 via the magnet. The tray portion 434 may also include holder slots 446, 448 similar to the holder slots of the previous embodiments for attaching an extension body, such as extension tray 141, thereto to increase the working surface and/or storage capacity of the ladder top 400.The sidewalls 435 of the upper body 404 include guide slots 450, 452 (see FIG. 8) that receive the rails 428, 430 of the lower body 402. The guide slots 450, 452 may couple the upper body 404 to the lower body 402 while permitting the upper body 404 to slide relative to the lower body 402 between the closed and open positions.

The ladder top 400 may include a lock 454 that may be used to secure the upper body 404 in the open position or closed position. The lock 454 may include an actuator 456 accessible to the user and operable to switch the lock 454 between a locked configuration and an unlocked configuration. The actuator 456 may be mounted to the upper body 404. In some approaches, the actuator 456 is mechanically coupled to a locking engagement portion such as a locking bar 458 such that movement of the actuator 456 moves the locking bar 458. For example, the actuator 456 may be twisted about an axis in directions 460, 462 (see FIG. 5A) to pivot the locking bar 458. The actuator 456 may be used to move the lock 454 to the locked configuration with the locking bar 458 in engagement with the lower body 402 and to the unlocked configuration with the locking bar 458 out of engagement with the lower body 402. In some embodiments, the actuator 456 is a key that can be removably inserted into an opening of the upper body 404 to lock or unlock the upper body 404. A user could thus remove the actuator 456 upon locking the ladder top 400, for example, in inhibit access to items stored in the ladder top 400.

In other forms, other types of locking mechanisms may be used to secure the upper body 404 relative to the lower body 402. For example, ladder top 400 may include a sweep lock having a rotatable cam latch mounted to the upper body 404 and a catch mounted to the lower body 402. The cam latch may be rotated into engagement with the catch to inhibit the upper body 404 from moving relative to the lower body 402. Conversely, the cam latch may be rotated out of engagement with the catch to permit the upper body 404 to move relative to the lower body 402. As another example, the ladder top 400 may include a deadbolt style lock having a deadbolt movably coupled to the upper body 404 and a catch on the lower body 402. The user may rotate an actuator to cause the deadbolt to move between a locked configuration where the deadbolt extends into the catch and an unlocked configuration where the deadbolt is withdrawn from the catch.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A ladder comprising:
a ladder top with one or more receiving slots, the ladder top configured to be securely coupled to rails of a step ladder;
an extension body including an elongate recess and one or more attachment protrusions,
the one or more attachment protrusions of the extension body being configured to engage with the one or more receiving slots of the ladder top to secure the extension body to the ladder top.

2. The ladder of claim 1 wherein the elongate recess is configured to receive and support an electronic device.

3. The ladder of claim 1 wherein a rear surface of the elongate recess is tapered in a range of about 5-10 degrees.

4. The ladder of claim 1 wherein the extension body includes a flange extending from a rear wall of the elongate recess.

5. The ladder of claim 1 wherein the extension body includes a plug holder.

6. The ladder of claim 1 wherein the extension body includes a tray portion for supporting one or more items at the ladder top.

7. The ladder of claim 6 wherein the tray portion of the extension body provides an extension surface that is substantially coplanar with an upper surface of the ladder top when the extension body is secured to the ladder top.

8. The ladder of claim 1 wherein the one or more protrusions of the extension body include cylindrical members and the one or more receiving slots define a cylindrical openings, wherein the cylindrical members of the one or more protrusions are slid axially into the cylindrical openings to secure the extension body to the ladder top.

9. A ladder comprising:
a first rail portion and a second rail portion hingedly movable relative to one another;
a ladder top including:
a lower body coupled to at least one of the first rail portion and second rail portion; and
an upper body slidably engaging the lower body such that the upper body is able to slide relative to the lower body between a first position and a second position.

10. The ladder of claim 9 wherein the lower body includes one or more storage compartments, wherein the one or more storage compartments are inaccessible when the upper body is in the first position and accessible when the upper body is in the second position.

11. The ladder of claim 9 wherein the upper body includes an opening to receive a tool and the lower body includes a slot aligned with the opening to receive at least a portion of the tool, the slot permitting the upper body to be moved between the first position and second position with at least a portion of the tool extending into the opening and the slot.

12. The ladder of claim 11, wherein the slot includes an open end to permit the tool to slide out of and into the slot as the upper body is moved between the first position and second position.

13. The ladder of claim 9 further comprising a locking mechanism configured to fix the upper body in the first position and/or the second position.

14. The ladder of claim 9 wherein the locking mechanism includes an actuator mounted to the upper body and operable to move a locking engagement portion into or out of engagement with the lower body to fix the upper body in at least one of the first position and second position.

15. The ladder of claim 14 wherein the actuator is rotatable about an axis to move the locking engagement portion.

16. The ladder of claim 9 wherein the upper body further includes one or more receiving slots to receive one or more protrusions of an extension body to secure the extension body to the upper body.

17. The ladder of claim 9 wherein the lower body includes a tray portion and extension portions extending outward of the tray portion, the upper body movable along the extension portions to expose the tray portion.

18. The ladder of claim 9 wherein the lower body includes one or more guide rails and the upper body slides along the one or more guide rails between the first position and second position.

19. The ladder of claim 9 wherein the upper body includes one or more guide slots engaging the lower body to facilitate movement of the upper body along the lower body between the first position and second position.

20. The ladder of claim 9 wherein the lower body includes a guide slot and the upper body includes a guide protrusion extending into the guide slot, wherein the guide protrusion moves along the guide slot as the upper body moves between the first position and second position.

21. The ladder of claim 9 wherein the upper body includes at least one magnetic attachment region.
